(19) United States
(12) Patent Application Publication
(10) Pub. No.: US 2012/0198348 A1
(43) Pub. Date: Aug. 2, 2012

(54) APPARATUS AND METHOD FOR PROVIDING INTEGRATED USER INFORMATION

(75) Inventor: Hye-Suk PARK, Seoul (KR)

(73) Assignee: PANTECH CO., LTD., Seoul (KR)

(21) Appl. No.: 13/249,320

(22) Filed: Sep. 30, 2011

(30) Foreign Application Priority Data
Jan. 31, 2011 (KR) 10-2011-0009470

(51) Int. Cl. G06F 3/048

(52) U.S. Cl. 715/739

(57) ABSTRACT

An apparatus and method for providing integrated user information is provided. An apparatus to provide integrated user information includes a user information storage unit to store first user information of a first contact user including at least one of name information of the first contact user, phone number information of the first contact user or identification information of the first contact user; and a control unit to acquire first social network information of the first contact user registered in a first application, to generate first integrated user information having the first user information of the first contact user and the first social network information of the first contact user, and to store the first integrated user information.

### CROSS-REFERENCE TO RELATED APPLICATION

This application claims priority from and the benefit under 35 U.S.C. §119(a) of Korean Patent Application No. 10-2011-0009470, filed on Jan. 31, 2011, which is incorporated by reference for all purposes as if fully set forth herein.

### BACKGROUND

1. Field

The following description relates to an apparatus and method for providing integrated user information.

2. Discussion of the Background

For a data communication in a mobile communication terminal, voice message and text message services have mainly been used among mobile communication terminal users before recent advent of Smart Phones. With the recent advent of Smart Phones, and the development of a mobile communication terminal apparatus into an open system, various types of applications are able to be installed in the mobile communication terminal apparatus according to users' preferences. Social network service related applications among the applications have operations of storing and managing information that may be similar to an operation used to manage information of a phonebook, for example, a user information providing unit that is implemented in the mobile communication terminal apparatus. For example, in order to perform a data communication with a friend through an application, such as ‘KaKaoTalk’, ‘Facebook’, and ‘Twitter’, a user of the mobile communication terminal apparatus should execute the application to confirm whether information of the friend is registered in social network information of the application. If the information of the friend is not registered in the social network information of the application, the user of the mobile communication terminal apparatus may need to execute another application that includes social network information of the friend or register the social network information of the friend in the application.

Conventional data communication method has limitations because the mobile communication terminal apparatus does not provide integrated user information. Each application has each piece of user information independently managed by each application. Accordingly, the user may need to execute each application to obtain specific user information. In addition, each application has limitations for sharing user information among applications, due to the absence of a standard format for managing user information. Further, in order to retrieve specific user information registered in an application, the application may need to be executed before retrieving the specific user information.

### SUMMARY

Exemplary embodiments of the present invention provide an apparatus and method for providing integrated user information having user information and social network information that is provided from one or more applications.

Additional features of the invention will be set forth in the description which follows, and in part will be apparent from the description, or may be learned by practice of the invention.

Exemplary embodiments of the present invention provide an apparatus to provide integrated user information including a user information storage unit to store first user information of a first contact user including at least one of name information of the first contact user, phone number information of the first contact user or identification information of the first contact user; and a control unit to acquire first social network information of the first contact user registered in a first application, to generate first integrated user information having the first user information of the first contact user and the first social network information of the first contact user, and to store the first integrated user information.

Exemplary embodiments of the present invention provide a method for providing integrated user information, including acquiring first social network information of a first contact user registered in a first application; determining whether first user information of the first contact user exists; integrating the first user information of the first contact user and the first social network information of the first contact user registered in the first application; generating first integrated user information comprising the first user information of the first contact user and the first social network information of the first contact user registered in the first application; and displaying the first integrated user information.

Exemplary embodiments of the present invention provide an apparatus to provide integrated user information including a user information storage unit to store first user information of a first contact user comprising identification information of the first contact user; a control unit to acquire first social network information of the first contact user registered in a first application and second social network information of the first contact user registered in a second application; a social network information combining unit to generate first integrated user information having the first user information of the first contact user, the first social network information of the first contact user, the second social network information of the first contact user, an icon of the first application and an icon of the second application; and a storage unit to store the first integrated user information.

It is to be understood that both forgoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram showing an apparatus to provide integrated user information having user information and social network information according to an exemplary embodiment of the present invention.

FIG. 2 is a diagram showing integrated user information having user information, social network information, and an icon of an application according to an exemplary embodiment of the present invention.

FIG. 3 is a diagram showing integrated user information associated with an icon tab of an application selected by a user according to an exemplary embodiment of the present invention.

FIG. 4 is a diagram showing integrated user information that is sorted based on execution history information according to an exemplary embodiment of the present invention.

FIG. 5 is a diagram showing a plurality of pieces of linked social network information that are related to specific user information according to an exemplary embodiment of the present invention.

FIG. 6 is a flowchart showing a method for providing integrated user information having user information and social network information according to an exemplary embodiment of the present invention.

FIG. 7 is a flowchart showing a method for displaying all of the user information included in integrated user information or selected information included in integrated user information according to an exemplary embodiment of the present invention.

Elements, features, and structures are denoted by the same reference numerals throughout the drawings and the detailed description, and the size and proportions of some elements may be exaggerated in the drawings for clarity and convenience.

### DETAILED DESCRIPTION OF THE ILLUSTRATED EMBODIMENTS

The following detailed description is provided to assist the reader in gaining a comprehensive understanding of the methods, apparatuses and/or systems described herein. Various changes, modifications, and equivalents of the systems, apparatuses and/or methods described herein will suggest themselves to those of ordinary skill in the art. Descriptions of well-known operations and structures are omitted to enhance clarity and conciseness.

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth herein. Rather, these exemplary embodiments are provided so that the present disclosure is thorough, and will fully convey the scope of the invention to those skilled in the art.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

It will be understood that for the purposes of this disclosure, “at least one of X, Y, and Z” can be construed as X only, Y only, Z only, or any combination of two or more items X, Y, and Z (e.g., XYZ, XYY, YZ, ZZ).

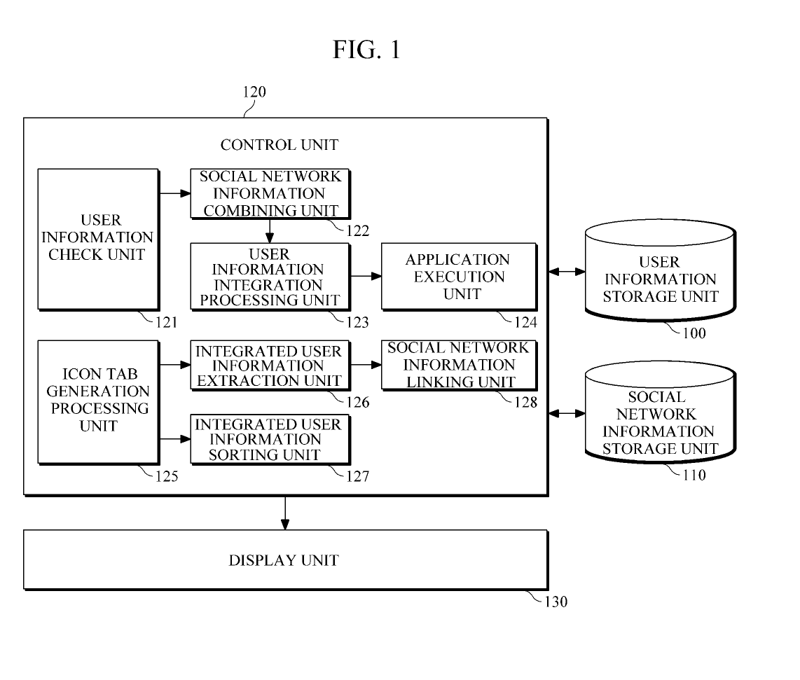

FIG. 1 is a block diagram showing an apparatus to provide integrated user information having user information and social network information according to an exemplary embodiment of the present invention.

As shown in FIG. 1, the apparatus may include a user information storage unit 100, a social network information storage unit 110 and a control unit 120. The apparatus may further include a display unit 130. The apparatus may include a mobile communication terminal apparatus.

The user information storage unit 100 stores user information, which may include name information, phone number information, address information and image information of other users. Here, other users may include friends, family, or other contacts of the owner of the mobile communication terminal apparatus. The user information may be inputted by the owner of the mobile communication terminal apparatus. Hereinafter, the owner or the user of a terminal apparatus may be referred to as a first user or a user, and one or more users, whose user information is acquired by the mobile communication apparatus, other than the owner may be referred to as a contact user or contact users. Further, the contact user may be a user whose user information is stored in the user information storage unit 100. In addition, the user information stored in the user information storage unit 100 may further include execution history information for each user and/or contact user. The execution history information may be obtained when corresponding user information is used. For example, if the first user retrieves information of a contact user included in the user information or performs a data communication with the contact user using an application, the execution history information for the contact user may be generated. The execution history information may include information of the contact user, information of the executed application, and usage time of the user information of the contact user. The social network information storage unit 110 may store a plurality of pieces of social network information for each of applications that are independently executed. The plurality of pieces of social network information may be distinguished by an application type. The application type may include a social network related application, an address book related application or a message related application. The social network information may include at least one of name information, phone number information, e-mail information, ID (identification) information and nickname information of a user and/or a contact user, which is registered in the application. The social network information may include data communication information and execution history information that are obtained through data communication between the first user and the contact user.

The control unit 120 acquires user information, which is related to the social network information stored in the social network information storage unit 110, among the plurality of pieces of user information stored in the user information storage unit 100 and integrates the acquired user information with the social network information corresponding to the acquired user information. The control unit 120 may control an execution of an application using integrated user information. The application is associated with the social network information integrated into the integrated user information. The control unit 120 may perform the above mentioned operations using the user information check unit 121 and the social network information combining unit 122 included in the control unit 120.

The user information check unit 121 may check whether user information related to at least one piece of social network information among the plurality of pieces of social network information stored in the social network information storage unit 110 exists in the user information storage unit 100. That is, the user information check unit 121 may retrieve social network information which is registered in at least one application among a plurality of applications, and compare the retrieved social network information with user information using at least one of name information, phone number information, e-mail information, ID information and nickname information of a user, included in the retrieved social network information. For each piece of the retrieved social network information, the user information check unit 121 determines whether corresponding user information, such as name information or phone number information, exists in the user information storage unit 100 by comparing the corresponding name information and phone number information included in the social network information with the user information. If user information, which corresponds to at least one piece of the retrieved social network information, exists, the social network information combining unit 122 integrates the user information with the corresponding social network information. In an example, the user information and the corresponding social network information may be integrated into integrated user information. The integrated user information may update the user information stored in the user information storage unit 100. Meanwhile, if user information, which corresponds to the retrieved social network information, does not exist, the social network information combining unit 122 may generate new user information corresponding to the retrieved social network information and integrate the generated new user information with the corresponding social network information. For example, if the user information includes name information and a phone number of a user and the social network information includes name information, phone name, e-mail address, ID information and nickname information of the corresponding user, the social network information combining unit 122 integrates the e-mail information, the ID information and the nickname information, which are not included in the user information, into the corresponding user information, thereby creating integrated user information. The integrated user information may update existing user information. Further, if user information, which is related to at least one of name information, phone number, e-mail information, ID information and nickname information of a contact user that is included in the social network information, does not exist, the social network information combining unit 122 may generate new user information corresponding to the social network information, and integrates the corresponding social network information into the generated new user information. The generated new user information may be stored in a new user information storage unit (not shown) or the user information storage unit 100. In this manner, the plurality of pieces of social network information registered to each of the applications may be integrated to the user information that is stored in the user information storage unit 100 or the generated new user information. Accordingly, a user may use social network information, which is not included in original user information, without searching or executing an application to retrieve the social network information.

The control unit 120 may further include a user information integration processing unit 123 and an application execution unit 124.

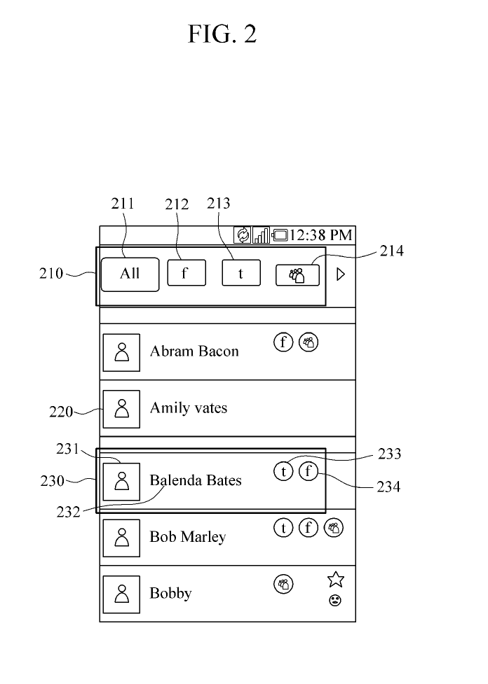

The user information integration processing unit 123 generates integrated user information including an icon of an application, which is related to social network information integrated into corresponding user information through the social network information combining unit 122, and user information, which is related to the social network information, and displays the generated integrated user information on a display unit 130. That is, the user information integration processing unit 123 performs a process of displaying all the user information stored in the user information storage unit 100 on the display unit 130. If, a piece of user information is integrated with a piece of social network information of an application into integrated user information through the social network information combining unit 122, the integrated user information and an icon of the application may be displayed on the display unit 130. Further, the integrated user icon may be generated by integrating a piece of user information, a piece of social network information of an application corresponding to the piece of user information, and an icon of the application. As shown in FIG. 2, the generated integrated user information is displayed on the display unit 130.

FIG. 2 is a diagram showing integrated user information having user information, social network information, and an icon of an application according to an exemplary embodiment of the present invention.

As shown in FIG. 2, user information 220 of a contact user, ‘Amily vates’, is displayed on a display unit. If the user information check unit 121 does not find social network information related to the user information 220 about ‘Amily vates’ from applications, the user information integration processing unit 123 may display the user information 220 on a display unit without an application icon. Meanwhile, if the user information check unit 121 identifies social network information of ‘Balenda Bates” from applications, such as Twitter®, and Facebook®, corresponding to user information of ‘Balenda Bates’ 231 and 232, the social network information combining unit 122 integrates the social network information about ‘Balenda Bates’ registered in the applications of Twitter and Facebook into the user information 231 and 232, thereby generating integrated user information of ‘Balenda Bates’ 230. Further, the integrated user information of ‘Balenda Bates’ 230 may include icons of applications 233 and 234. In this manner, the user information integration processing unit 123 may generate integrated user information including an icon of an application, which is associated with social network information, and the corresponding user information integrated with the social network information, and may display the generated integrated user information on the display unit.

Accordingly, the user information about ‘Balenda Bates’ 231 and 232 included in the user-integrated information 230 and icons of Twitter and Facebook 233 and 234 may be displayed on a display unit.

The application execution unit 124 may execute an application which is associated with an icon that is included in the integrated user information. For example, as shown in FIG. 2, if an icon of Twitter 233 is selected by a user among icons included in the integrated user information about ‘Balenda Bates’ 230, the application execution unit 124 executes an application associated with Twitter, thereby displaying social network information about ‘Balenda Bates’ on the display unit. Specifically, the application execution unit 124 may execute Twitter application and may display Twitter page of ‘Balenda Bates’, execute a chatting application of Twitter with ‘Balenda Bates’, or display social network information of ‘Balenda Bates’. That is, integrated user information including an icon, which is associated with an application to which each user is registered, and user information may be provided. Accordingly, a user may see listed user information along with registered social network applications of each person at a glance, so that the user may use social network applications with a selected user with less effort.

Meanwhile, the control unit 120 may further include an icon tab generation processing unit 125 and an integrated user information extracting unit 126. The icon tab generation processing unit 125 generates icon tabs for each application 212, 213 and 214 and a whole view tab 211 such that the icon tabs and the whole view tab 211 are displayed in a tab 210. The icon tabs for each application 212, 213 and 214 may include icon tabs for social network related applications such as Twitter and Face book, an icon tab for address book related applications, or an icon tab for message related applications, such as KaKaoTalk. The tab 210 including the icon tabs 212, 213 and 214 and the whole view tab 211 generated through the icon tab generating processing unit 125 may be placed at an upper side of a displayed image as shown in FIG. 2. However, the position of the tab 210 is not limited thereto. In an example, the icon tabs 212, 213 and 214 and the whole view tab 211 may be placed at a lower side or left/right sides of a displayed image. In addition, the icon tabs may be hidden and may be displayed if a corresponding input is received. If at least one tab is selected among the icon tabs for each application 212, 213 and 214 and the whole view tab 211, the integrated user information extracting unit 126 may display integrated user information associated with the selected tab on a display unit. That is, if a user selects the whole view tab 211, the integrated user information extracting unit 126 may display all of the integrated user information on the display unit. If a user selects at least one icon tab among the icon tabs for each application, the integrated user information extracting unit 126 may extract integrated user information which is associated with the selected icon tab and may display the extracted integrated user information on the display unit. For example, if the user selects both the icon tab of ‘Facebook’ 212 and the icon tab of ‘Twitter’ 213, the integrated user information extracting unit 126 may extract integrated user information associated with ‘Twitter’ and ‘Facebook’, and may display the extracted integrated user information on the display unit. Thus, the user may view a portion of the integrated user information associated with one or more applications based on user's selection of an application.

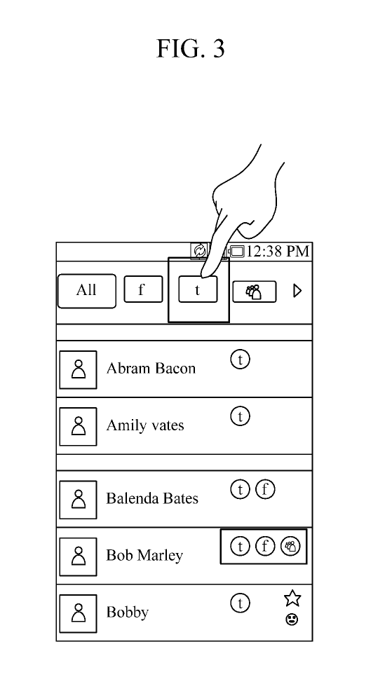

FIG. 3 is a diagram showing integrated user information associated with an icon tab of an application selected by a user according to an exemplary embodiment of the present invention.

As shown in FIG. 3, if a user selects an icon tab of an application associated with Twitter among the icon tabs for each application and the whole view tab, the integrated user information extracting unit 126 may extract integrated user information including an icon of the application associated with Twitter among all of the integrated user information. If the user selects an icon tab of an application, the user may more conveniently identify contact users who registered in the application through displayed integrated user information associated with the application. The integrated user information extracting unit 126 may extract integrated user information associated with an application among all of the integrated user information, and may sort the extracted integrated user information associated with the application. The integrated user information extracting unit 126 may sort the extracted integrated user information in an alphabetical order or in time order.

In addition, if at least one icon tab is selected by a user, the integrated user information extracting unit 126 extracts integrated user information associated with the selected icon tab. Further, the integrated user information extracting unit 126 may execute an application associated with the selected icon tab, thereby displaying a plurality of pieces of social network information about all of the contact users who are associated with the application. Further, the integrated user information extracting unit 126 may extract execution history information associated with a selected application, and may display the extracted integrated user information or social network information associated with the selected application based on the execution history information. The execution history information may include a start time of a data communication, an end time of the data communication, and an application type. In an example, the extracted integrated user information may be displayed in the order of the start time of the data communication, thereby listing integrated user information from a contact user with whom the most recent data communication is executed.

Further, the icon tab generation processing unit 125 may generate an execution time related sorting tab, which is related to execution time of all the user information including the integrated user information, and may display the execution time related sorting tab. The execution time related sorting tab may sort integrated user information extracted by the integrated user information extracting unit 126 or all of the integrated user information in the order of execution time. The execution time may include an execution start time of an application, a start time of a data communication using an application, an access time to integrated user information, an access time to social network information, and the like. If an execution time related sorting tab is selected, an integrated user information sorting unit 127 may extract execution history information, which is included in each piece of the user information or the integrated user information that is extracted through the integrated user information extracting unit 126, and sort each piece of the user information or the integrated user information in the order of time and date. That is, user information or social network information of an application, which is associated with an icon included in integrated user information, includes execution history information. The execution history information may include information retrieving history information, and data communication history information. For example, the execution history information may include retrieval time for social network information of a contact user as the information retrieving history information. Further, the execution history information may include data communication time information with a contact user as the data communication history information. The execution history information may be separately generated for each contact user. Further, if a user selects the execution time related sorting tab, the integrated user information sorting unit 127 may extract execution history information that is stored in all the integrated user information or selected integrated user information that is extracted through the integrated user information extracting unit 126, and sorts each piece of the user-integrated information in the order of time and date.

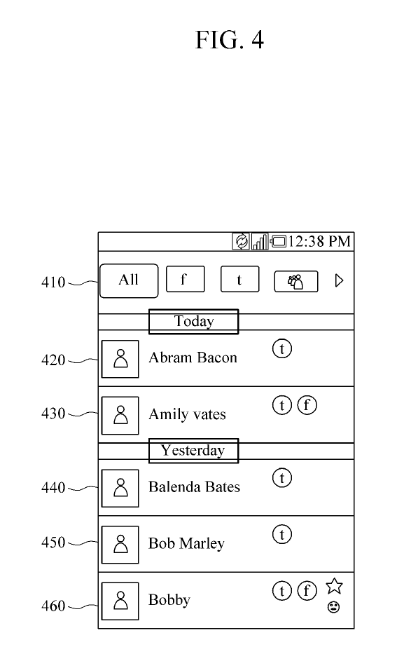

An example of the execution result of the integrated user information sorting unit 127 is shown in FIG. 4.

FIG. 4 is a diagram showing integrated user information that is sorted based on execution history information according to an exemplary embodiment of the present invention.

If a user selects the execution time related sorting tab (“a time tab”), the integrated user information sorting unit 127 sorts each piece of extracted integrated user information based on the execution history information. For example, a plurality of pieces of integrated user information that are registered in a Twitter related application are extracted by the integrated user information extracting unit 126 and displayed on a display unit as shown in FIG. 3. If a user selects the execution time related sorting tab, the integrated user information sorting unit 127 may extract execution history information about each piece of the extracted integrated user information that is registered in the Twitter related application, and sort the each piece of the integrated user information in the order of time and date as shown in FIG. 4. That is, the integrated user information sorting unit 127 may acquire a plurality of pieces of social network information of the Twitter related application from the social network information storage unit 110, and acquire user information related social network information, which are associated with user information included in the integrated user information, from the acquired plurality of pieces of social network information. Then, the integrated user information sorting unit 127 may extract execution history information which is included in the user information related social network information and sorts the extracted integrated user information in the order of time and date as shown in FIG. 4.

For example, integrated user information about ‘Abram Bacon’ 420 and integrated user information about ‘Amily vates’ 430, which are executed today, are displayed at the upper side of the display unit, and integrated user information about ‘Balenda Bates’ 440, integrated user information about ‘Bob Marley’ 450 and integrated user information about ‘Bobby’ 460, which were executed yesterday, are displayed at the lower side of the display unit.

Displaying methods of the integrated user information and the user information are not limited thereto. The user-integrated information sorting unit 127 may extract execution history information included in all of the integrated user information or the user information and display the integrated user information or the user information on the display unit in the order of time and date.

Referring back to FIG. 1, the control unit 120 may further include a social network information linking unit 128. If user information included in at least one piece of integrated user information is selected among a plurality of pieces of integrated user information, which are extracted from the integrated user information extracting unit 126, the social network linking unit 128 may acquire all social network information related to the selected user information among a plurality of pieces of social network information of an application that is related to the extracted integrated user information in the social network information storage unit 110, and display the acquired social network information. That is, the social network information linking unit 128 acquires social network information of applications, which are related to the selected user information, using the selected user information, and displays the acquired social network information. Further, the social network information linking unit 128 may further acquire another pieces of social network information that is related to the selected user information among the plurality of pieces of social network information of the application and display all of the acquired social network information. In addition, the social network information linking unit 128 acquires all information about a contact user, such as SMS message, call sending history and call receiving history of the contact user using the user information about the contact user included in integrated user information, and displays the acquired information on the display unit. Further, the social network information linking unit 128 may extract execution history information, which is included each of the information about the contact user, that is acquired using the user information, and sorts all of the information about the contact user in the order of time and date.

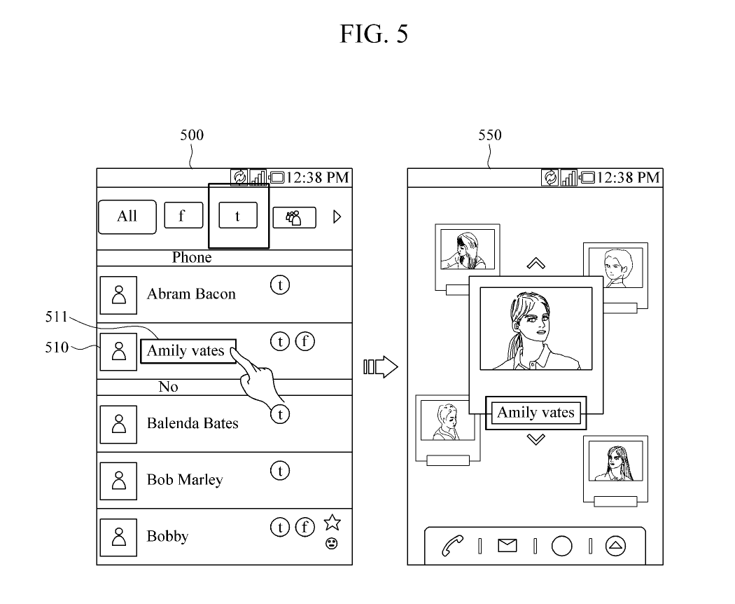

As described above, a plurality of pieces of social network information related to the selected user information may be linked through the social network information liking unit 128 and may be displayed through a display unit as shown in FIG. 5.

FIG. 5 is a diagram showing a plurality of pieces of linked social network information that are related to specific user information according to an exemplary embodiment of the present invention.

As shown in FIG. 5, if an icon tab of an application associated with Twitter is selected by a user, the integrated user information extracting unit 126 extracts a plurality of pieces of integrated user information of contact users who are registered in an application, which is associated Twitter, and displays the plurality of pieces of extracted integrated user information on display unit 500. If user information included in a piece of extracted integrated user information is selected, the social network information linking unit 128 acquires social network information which is related to the selected user information among a plurality of pieces of social network information, which are related to Twitter, in the social network information storage unit 110. For example, if user information about ‘Amily vates’ 511 is selected, the social network information linking unit 128 acquires social network information about ‘Amily vates’ among the plurality of social network information related to Twitter in the social network information storage unit 110. If the social network information about ‘Amily vates’ is acquired, other pieces of social network information that are related to data communication information is acquired based on the data communication information included in the social network information about ‘Amily vates’. For example, if the data communication information included in the acquired social network information is related to a social meeting, the social network information linking unit 128 acquires other pieces of social network information including data communication information that are related to the corresponding social meeting. Thereafter, the acquired social network information about ‘Amily vates’ and the other pieces of social network information that are acquired based on data communication information of the social meeting included in the social network information about ‘Amily vates’ are displayed on the display unit 550. Further, the acquired social network information about ‘Amily vates’ and data communication information may be displayed.

Thus, a user may check social network information, which is related to selected user information, and other pieces of social network information, which are related to the acquired social network information, or the user may check social network information, which is related to selected user information, and corresponding data communication information.

Hereinafter, a method for providing integrated user information having social network information and user information will be described in more detail.

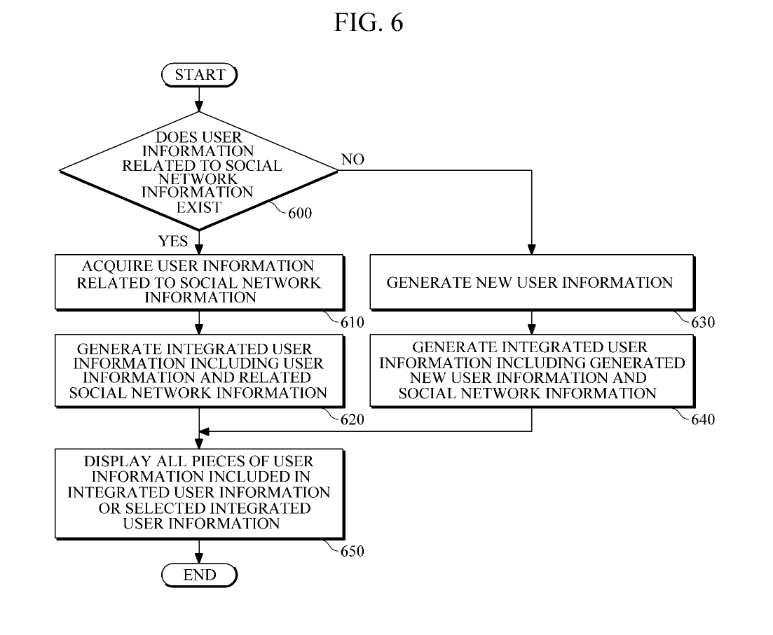

FIG. 6 is a flowchart showing a method for providing integrated user information having user information and social network information according to an exemplary embodiment of the present invention.

As shown in FIG. 6, an apparatus identifies user information, which is related to social network information of an application, among a plurality of pieces of user information including name information and phone number information of contact users (600). The application includes a social network related application, an address book related application or a message related application. The social network information includes at least one of name information, phone number information, e-mail information, ID information and nickname information of contact users who are registered in the application. If user information related to a piece of social network information of an application is identified, the apparatus acquires the identified user information (610), and generates integrated user information by integrating the acquired user information with the related social network information (620). If user information related to social network information is not identified, the apparatus generates new user information corresponding to the social network information (630) and generates integrated user information having the generated new user information and the corresponding social network information (640). The integrated user information is information that is obtained by combining the acquired user information with the corresponding social network information. For example, if the user information includes name information and phone number information of a contact user, and the social network information includes name information, phone number information, e-mail information, ID information and nickname information of the contact user, the apparatus combines the e-mail information, the ID information and the nickname information, which are not included in the user information, into the user information, thereby generating the integrated user information. As described above, a plurality of pieces of social network information, which are stored separately for each of application, may be combined with corresponding user information. Accordingly, a user may use social network information that is not included in original user information through integrated user information without searching or executing an application corresponding to the social network information.

The integrated user information may include user information, related social network information of an application, and an icon of the application (see FIG. 2). As shown in FIG. 2, if the integrated user information including user information and an icon of an application is displayed on a display unit, and the icon included in the integrated user information is selected, the apparatus executes the application corresponding to the selected icon. For example, if the icon included in the integrated user information is an icon of a Twitter related application and the icon is selected, the apparatus executes the Twitter related application.

If the integrated user information is generated, the apparatus displays all of the user information included in the integrated user information or a piece of the integrated user information that is selected from the integrated user information on the display unit (650).

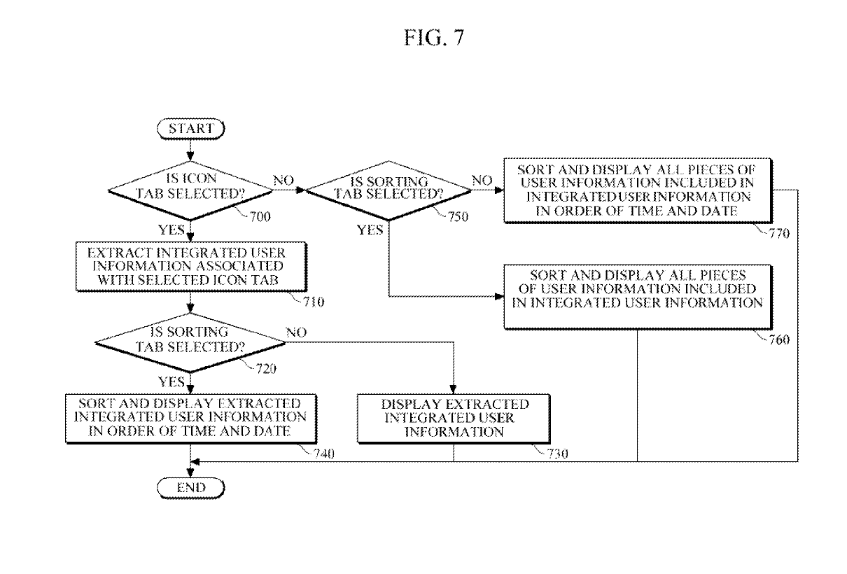

Exemplary embodiments of the present invention provide a method for displaying all of the user information included in the integrated user information or displaying selected information included in the integrated user information with reference to FIG. 7.

FIG. 7 is a flowchart showing a method for displaying all of the user information included in integrated user information or selected information included in integrated user information according to an exemplary embodiment of the present invention.

Referring to FIG. 7, an apparatus may determine whether at least one icon tab is selected by a user among icon tabs of applications displayed on a display unit (700). If one or more icon tabs are selected by a user among icon tabs of multiple applications displayed on the display unit, the apparatus extracts some pieces of integrated user information, each of which includes an icon of an application which is associated with one of the selected icon tabs (710). If the integrated user information including the icon of application that is associated with the selected icon tab is extracted, the apparatus determines whether an execution time related sorting tab is selected by a user (720). If the execution time related sorting tab is not selected by a user, the may display the extracted integrated user information on the display unit in an alphabetical order (730).

If the execution time related sorting tab is selected by a user, the apparatus may extract execution history information that is included in each of the extracted integrated user information and display the extracted integrated user information in the order of time or date (740). That is, if the execution time related sorting tab is selected by a user, the apparatus acquires a plurality of pieces of social network information of an application, which are associated with an icon tab of the application that is selected by a user, among a plurality of pieces of social network information of applications. Thereafter, the apparatus acquires one or more pieces of social network information, which are related to user information included in the extracted integrated user information, among the acquired plurality of pieces of social network information. Thereafter, the apparatus may extract execution history information included in the one or more pieces of social network that are related to the user information, and sort the extracted integrated user information in the order of time and date.

If at least one icon tab is not selected by a user among icon tabs of multiple applications displayed on the display unit (700), the apparatus may determine whether the execution time related sorting tab is selected (750). The execution time related sorting tab is a sorting tab to sort the extracted integrated user information based on an execution time included in user information, social network information, or integrated user information. If the execution time related sorting tab is not selected by a user, the apparatus displays all of the user information included in the integrated user information on the display unit according to a determined sorting condition, for example, an alphabetical order (760). In an example, the apparatus may extract name information included in each of the user information included in the integrated user information and display the integrated user information in an alphabetical order based on the name information.

If the execution time related sorting tab is selected by a user, the apparatus may extract execution history information that is included in each of the user information included in the integrated user information and display each of the user information included in the integrated user information in the order of time and/or date (770). That is, if the execution time related sorting tab is selected by a user, the apparatus may extract execution history information, and sort all the user information in the order of time and/or date. The execution history information may be included in each of the user information, such as name information, phone number information, e-mail information, and the like. Further, the execution history information may be included in each of social network information integrated in the integrated user information. For example, execution history information included in social network information of a Twitter related application may include chatting time information using Twitter chatting application, retrieving time of social network information of the Twitter related application. Further, the execution history information may be distinguished by each contact user. In sorting the integrated user information, the apparatus acquires execution history information of user information which is included in the integrated user information. In addition, the apparatus acquires social network information that is related to the user information included in the integrated user information among a plurality of pieces of social network information that are associated with an application of an icon which is included in the integrate user information. Thereafter, the apparatus compares the execution history information of the user information with execution history information that is included in the acquired social network information, and acquires the most recent execution history information between the two pieces of execution history information. In this manner, the apparatus sorts all the user information included in the integrated user information in the order of execution time of all the user information included in the integrated user information.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. An apparatus to provide integrated user information, the apparatus comprising:
a user information storage unit to store first user information of a first contact user comprising at least one of name information of the first contact user, phone number information of the first contact user or identification information of the first contact user; and
a control unit to acquire first social network information of the first contact user registered in a first application, to generate first integrated user information having the first user information of the first contact user and the first social network information of the first contact user, and to store the first integrated user information.

2. The apparatus of claim 1, wherein the first application comprises at least one of a social network related application, an address book related application or a message related application.

3. The apparatus of claim 1, wherein the control unit comprises:
a user information check unit to determine whether the first user information of the first contact user is stored in the user information storage unit; and
a social network information combining unit to generate the first user information of the first contact user based on the first social network information of the first contact user if the user information check unit determines that the first user information of the first contact user is not stored in the user information storage unit, and to integrate the first user information of the first contact user and the first social network information of the first contact user into the integrated user information.

4. The apparatus of claim 1, wherein the control unit comprises:
a user information integration processing unit to generate the first integrated user information comprising an icon of the first application, and the first user information of the first contact user; and
an application execution unit to execute the first application if the icon of the first application is selected.

5. The apparatus of claim 4, wherein the control unit further comprises:
an icon tab generation processing unit to generate an icon tab of the first application and a whole view tab, and to display the icon tab of the first application and the whole view tab on a display unit; and
an integrated user information extracting unit to extract the first integrated user information on the display unit if the icon tab of the first application or the whole view tab is selected, and to display the first integrated user information on the display unit if the first integrated user information is extracted.

6. The apparatus of claim 5, wherein the integrated user information extracting unit executes the first application to extract second social network information related to the first integrated user information, and displays the second social network information.

7. The apparatus of claim 6, wherein the second social network information comprises at least one of social network information of the first contact user registered in the first application, and social network information of a contact user of the first contact user registered in the first application.

8. The apparatus of claim 5, wherein the icon tab generation processing unit generates a first sorting tab to sort one or more pieces of integrated user information extracted by the integrated user information extracting unit in an order of an execution time of the integrated user information, and displays the first sorting tab on the display unit, and
the control unit further comprises an integrated user information sorting unit to extract first execution history information comprised in the first integrated user information if the first sorting tab is selected, and to sort the first integrated user information among the one or more pieces of the integrated user information based on the first execution history information.

9. The apparatus of claim 5, wherein the control unit further comprises:
a social network linking unit to acquire second social network information based on the first social network information of the first contact user, to link the second social network information and the first integrated user information, and to display the second social network information.

10. The apparatus of claim 9, wherein the second social network information comprises at least one of social network information of the first contact user registered in the first application, social network information of a contact user of the first contact user registered in the first application, social network information of the first contact user registered in a second application, and social network information of a contact user of the first contact user registered in the second application.

11. The apparatus of claim 1, further comprising:
a social network information storage unit to store the first social network information of the first contact user registered in the first application,
wherein the first social network information of the first contact user comprises at least one of name information of the first contact user, phone number information of the first contact user, e-mail information of the first contact user, identification information of the first contact user, and nickname information of the first contact user.

12. A method for providing integrated user information, the method comprising:
acquiring first social network information of a first contact user registered in a first application;
determining whether first user information of the first contact user exists;
integrating the first user information of the first contact user and the first social network information of the first contact user registered in the first application;
generating first integrated user information comprising the first user information of the first contact user and the first social network information of the first contact user registered in the first application; and
displaying the first integrated user information.

13. The method of claim 12, further comprising:
generating the first user information of the first contact user based on the first social network information of the first contact user registered in the first application if it is determined that the first user information of the first contact user does not exist.

14. The method of claim 12, wherein the first application comprises at least one of a social network related application, an address book related application or a message related application, and
the first social network information of the first contact user comprises at least one of name information, phone number information, e-mail information, identification information and nickname information of the first contact user.

15. The method of claim 12, wherein the first integrated user information comprises an icon of the first application.

16. The method of claim 12, further comprising:
integrating an icon of the first application to the first integrated user information; and
displaying second social network information registered in the first application if the icon of the first application is selected.

17. The method of claim 16, further comprising:
determining whether an icon tab of the first application or a whole view tab is selected; and
extracting the first integrated user information if it is determined that the icon tab of the first application or the whole view tab is selected,
wherein displaying of the first integrated user information is performed if the first integrated user information is extracted.

18. The method of claim 12, further comprising:
sorting integrated user information of multiple contact users comprising the first integrated user information and a second integrated user information of a second contact user in an alphabetical order or a time order;
displaying the integrated user information of the multiple contact users in the alphabetical order or the time order, if a sorting tab is selected.

19. The method of claim 18, wherein sorting of the integrated user information of the multiple contact users is performed based on execution history information comprised in each of the first integrated user information and the second integrated user information.

20. An apparatus to provide integrated user information, the apparatus comprising:
a user information storage unit to store first user information of a first contact user comprising identification information of the first contact user;
a control unit to acquire first social network information of the first contact user registered in a first application and second social network information of the first contact user registered in a second application;
a social network information combining unit to generate first integrated user information having the first user information of the first contact user, the first social network information of the first contact user, the second social network information of the first contact user, an icon of the first application and an icon of the second application; and
a storage unit to store the first integrated user information.
